(19) United States
(12) Patent Application Publication
(10) Pub. No.: US 2026/0185839 A1
(43) Pub. Date: Jul. 2, 2026

(54) SYSTEM AND METHOD FOR DETERMINING A ROUTE FOR A VEHICLE TO UTILIZE WHEN BEING REMOTELY CONTROLLED BY SIGNALS TRANSMITTED FROM A NON-TERRESTRIAL NETWORK NODE

(71) Applicant: Toyota Motor Engineering & Manufacturing North America, Inc., Plano, TX (US)

(72) Inventors: Taishi Sase, Mountain View, CA (US); Sergei S. Avedisov, Redwood City, CA (US); Xunbi Ji, Mountain View, CA (US); Takayuki Shimizu, Mountain View, CA (US); Onur Altintas, Sunnyvale, CA (US); Akila C. Ganlath, Fremont, CA (US); Chunghan Lee, Mountain View, CA (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/007,819

(22) Filed: Jan. 2, 2025

(51) Int. Cl. G01C 21/34; G05D 1/226

(52) U.S. Cl. CPC G01C 21/3461; G05D 1/226

(57) ABSTRACT

A system for determining a route for a vehicle to utilize when being remotely controlled by signals transmitted from a non-terrestrial network node to the vehicle includes a processor and a memory in communication with the processor. The memory includes instructions that, when executed by the processor, cause the processor to determine a route from an origin to a destination within a defined drivable area based on a future trajectory of the non-terrestrial network node when the vehicle travels from the origin to the destination and obstacle information of obstacles that could inhibit the vehicle from receiving control signals from the non-terrestrial network node.

### TECHNICAL FIELD

The subject matter described herein relates, in general, to systems and methods for controlling a vehicle by signals transmitted from a non-terrestrial network node to the vehicle and, more specifically, to determining routes for the vehicle to utilize when being controlled remotely to prevent signal interruption.

### BACKGROUND

The background description provided is to present the context of the disclosure generally. Work of the inventor, to the extent it may be described in this background section, and aspects of the description that may not otherwise qualify as prior art at the time of filing, are neither expressly nor impliedly admitted as prior art against the present technology.

Some vehicles can be driven remotely, wherein information can be exchanged between an operator, which may be a human operator or an autonomous control system, and a remote vehicle to cause the vehicle to move from one location to another. For example, the operator, which may be located in a teleoperation center, may receive camera and/or other sensor information from the vehicle so that the operator can comprehend the environment in which the vehicle is operating. The operator provides control inputs which are then transmitted in real-time to the vehicle, wherein the vehicle then executes these instructions.

Due to the real-time communication demands, the remote operation of the vehicle generally relies on high-speed networks, such as fifth generation (“5G”) cellular networks, which can provide significant bandwidth and low latency times required to safely operate the vehicle from a remote teleoperation center. However, the deployment of these 5G cellular networks may be limited in certain locations, especially remote locations, preventing vehicles from being remotely operated in these locations.

### SUMMARY

This section generally summarizes the disclosure and is not a comprehensive explanation of its full scope or all its features.

In one embodiment, a system for determining a route for a vehicle to utilize when being remotely controlled by signals transmitted from a non-terrestrial network node to the vehicle includes a processor and a memory in communication with the processor. The memory includes instructions that, when executed by the processor, cause the processor to determine a route from an origin to a destination within a defined drivable area based on a future trajectory of the non-terrestrial network node when the vehicle travels from the origin to the destination and obstacle information of obstacles that could inhibit the vehicle from receiving control signals from the non-terrestrial network node.

In another embodiment, a method for determining a route for a vehicle to utilize when being remotely controlled by signals transmitted from a non-terrestrial network node to the vehicle includes determining a route from an origin to a destination within a defined drivable area based on a future trajectory of the non-terrestrial network node when the vehicle travels from the origin to the destination and obstacle information of obstacles that could inhibit the vehicle from receiving control signals from the non-terrestrial network node and controlling the vehicle to travel along the route with the control signals from the non-terrestrial network node. In addition to considering non-terrestrial network node trajectory and object information, other constraints may also be considered as well such as travel time, vehicle speed, communication price cost, and the like.

In yet another embodiment, a non-transitory computer-readable medium includes instructions that, when executed by a processor, cause the processor to determine a route from an origin to a destination within a defined drivable area based on a future trajectory of a non-terrestrial network node that will relay control signals to a vehicle when the vehicle travels from the origin to the destination and obstacle information of obstacles that could inhibit the vehicle from receiving control signals from the non-terrestrial network node and control the vehicle to travel along the route with the control signals from the non-terrestrial network node.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements, or multiple elements may be designed as one element. In some embodiments, an element shown as an internal component of another element may be implemented as an external component and vice versa. Furthermore, elements may not be drawn to scale.

FIG. 1 illustrates an example of a route determination system being utilized to determine an appropriate route for a vehicle to utilize so that the vehicle can be remotely controlled from a teleoperation center.

FIG. 2 illustrates a more detailed view of the vehicle that may be remotely controlled from a teleoperation center.

FIGS. 3-5 illustrate different examples of routes that may be utilized by a vehicle so that the vehicle can be remotely controlled from the teleoperation center.

FIG. 6 illustrates one example of a method used to determine a route for a vehicle to utilize so that the vehicle can be remotely controlled from a teleoperation center.

### DETAILED DESCRIPTION

Described are systems and methods for determining one or more routes for a vehicle to utilize so that the vehicle can be remotely controlled from a teleoperation center. As mentioned in the background section, remotely controlling a vehicle requires a high-bandwidth and low-latency connection between the vehicle and the teleoperation center. Moreover, sensor information from the vehicle, which can include information from a number of different sensors, including cameras, radar sensors, sonar sensors, light detection and ranging (LIDAR) sensors, and the like, needs to be provided to a teleoperation center in a timely manner. In addition, signals from the teleoperation center must be sent to the vehicle in an equally timely manner. Failure to send and/or receive information from the teleoperation center and/or the vehicle may result in an unsafe operating condition.

As mentioned in the background section, 5G cellular communication networks provide high-bandwidth and low-latency communication capabilities well-suited for remotely controlling a vehicle. However, 5G cellular communication networks may see only limited deployment in certain areas, especially in more rural areas, essentially preventing remote operation of a vehicle in these areas.

Non-terrestrial network nodes, such as High-Altitude Platform Stations (“HAPS”), unmanned aerial vehicles (“UAVs”) networks, and Low-Earth orbit (“LEO”) satellites may generally have both high bandwidth and low-latency capabilities. For example, LEO satellites are satellites that generally orbit the Earth at an altitude of up to approximately 2000 km. These satellites are notable for being able to provide high-bandwidth and low-latency communications. However, because these satellites typically operate using high-frequency bands, they are more susceptible to signal degradation from obstructions, such as buildings, weather conditions, trees, bridges, and other objects. Further still, due to the relatively low orbital altitude of the satellites, it is not unusual for these satellites to only maintain a line of sight for a relatively short period, usually between 10-30 minutes.

The systems and methods described herein determine an appropriate route for a vehicle to utilize that takes into account the future trajectory of one or more non-terrestrial network nodes that may be utilized to relay signals to and from the vehicle as well as object information detailing information regarding any objects that may interfere with the signals being sent between the vehicle and one or more non-terrestrial network nodes. Using this information, an appropriate route is determined for the vehicle to utilize that allows the vehicle to be able to sufficiently communicate with the non-terrestrial network node and avoid any potential signal disruptions caused by objects, thereby allowing teleoperation of the vehicle using the non-terrestrial network nodes, instead of a more traditional 5G cellular communication network, which may not be available. In addition to considering non-terrestrial network node trajectory and object information, other constraints may also be considered as well such as travel time, vehicle speed, communication price cost, and the like.

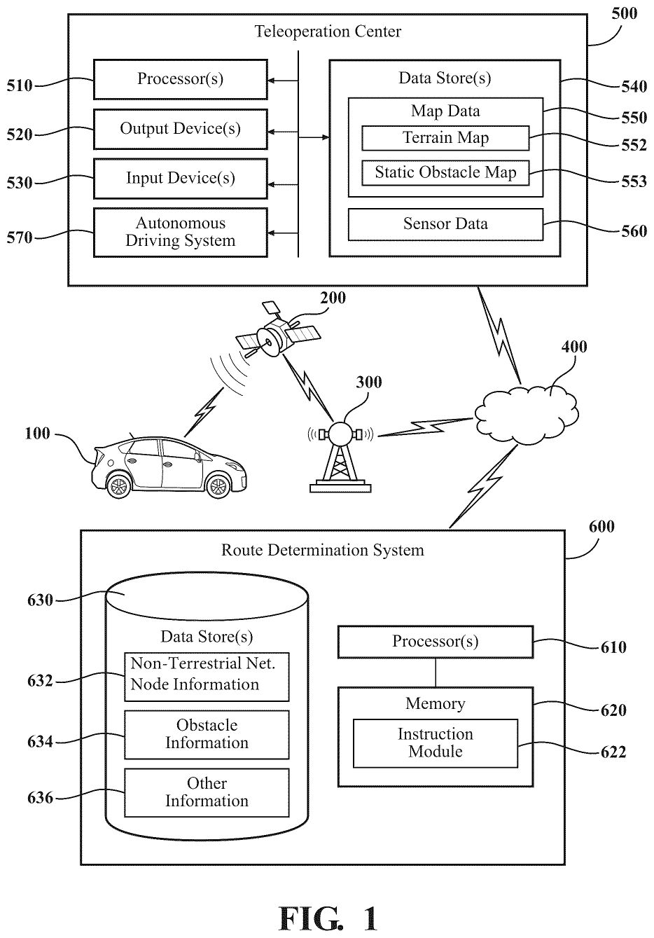

Referring to FIG. 1, illustrated is one example of a scenario involving the remote control of a vehicle 100 that involves a non-terrestrial network node 200. The non-terrestrial network node can take any one of a number of different forms, such as HAPS, UAVs, and/or LEO satellites. In this example, the vehicle 100 communicates in a bidirectional manner with a teleoperation center 500, such that a human operator located at the teleoperation center 500 and/or an autonomous driving system 570 can remotely operate the vehicle 100 so as to be able to cause the vehicle 100 to move from one location to another. As will be described in greater detail later, the vehicle 100 may include a number of different sensors that are able to sense the environment around the vehicle 100 and send this information to the teleoperation center 500, wherein a human operator and/or the autonomous driving system 570 will utilize this information to generate one or more command signals for controlling the operation of the vehicle 100.

The signals being sent between the vehicle 100 and the teleoperation center 500 are relayed through the non-terrestrial network node 200. The non-terrestrial network node 200 is in communication with the base station 300, which is in communication with the network 400, and, in turn, is in communication with the teleoperation center 500. In this example, the base station 300 may be a 5G cellular communication base station. However, it should be understood that base station 300 may be a more traditional satellite base station that can send and receive signals from the non-terrestrial network node 200 and may be connected to the network 400 through a wired or wireless connection.

Also shown is a route determination system 600 that can determine one or more routes for the vehicle 100 to utilize so as to be able to have appropriate and unhindered communication with the non-terrestrial network node 200. As will be explained in greater detail later, the route determination system 600 may determine the future trajectories of one or more non-terrestrial network nodes, such as the non-terrestrial network node 200, and the location of any obstacles that may negatively impact communication between the vehicle 100 and the non-terrestrial network node 200. Using this information and potentially other information, such as travel time, communication cost, vehicle speed, etc., the route determination system 600 determines the appropriate route for the vehicle 100 to utilize so as to allow the remote operation of the vehicle 100 from the teleoperation center 500 using one or more non-terrestrial network nodes, such as the non-terrestrial network node 200. By so doing, remote operation of the vehicle 100 may be possible in locations where more advanced cellular networks, such as 5G cellular networks, are not available.

Turning attention to the teleoperation center 500, in one example, the teleoperation center 500 includes one or more processor(s) 510 that are in communication with one or more output device(s) 520 and one or more input device(s) 530. In one example, the output device(s) 520 may be one or more displays and/or audible devices that are able to convey information collected from the sensors of the vehicle 100 to a human operator. The input device(s) 530 may be one or more input devices that allow a human operator to provide input for controlling the vehicle 100. In one example, the input device(s) 530 may include a steering wheel, one or more pedals, buttons, switches, or other devices used to control the operation of the vehicle 100, especially the movement of the vehicle 100 from one location to another.

As mentioned briefly before, instead of utilizing a human operator, the teleoperation center 500 may include an autonomous driving system 570 that is able to receive one or more inputs from the sensors of the vehicle 100 and generate one or more driving commands for controlling the motion of the vehicle 100. For example, the autonomous driving system 570 can be configured to receive data from the sensor system and/or any other type of system capable of capturing information relating to the vehicle 100 and/or the external environment of the vehicle 100. In one or more arrangements, the autonomous driving system 570 can use such data to generate one or more driving scene models. The autonomous driving system 570 can determine the position and velocity of the vehicle 100. The autonomous driving system 570 can determine the location of obstacles, obstacles, or other environmental features, including traffic signs, trees, shrubs, neighboring vehicles, pedestrians, etc.

The autonomous driving system 570 can be configured to determine travel path(s), current autonomous driving maneuvers for the vehicle 100, future autonomous driving maneuvers, and/or modifications to current autonomous driving maneuvers based on data acquired by the sensor system of the vehicle 100, driving scene models, and/or data from any other suitable source “Driving maneuver” means one or more actions that affect the movement of a vehicle. Examples of driving maneuvers include accelerating, decelerating, braking, turning, moving in a lateral direction of the vehicle 100, changing travel lanes, merging into a travel lane, and/or reversing, to name a few possibilities. The autonomous driving system 570 can be configured to implement determined driving maneuvers by transmitting appropriate control signals to the vehicle 100.

The teleoperation center 500 may also include one or more data store(s) 540 for storing one or more types of data. In one or more arrangements, the data store(s) 540 can include map data 550. The map data 550 can include maps of one or more geographic areas. In some instances, the map data 550 can include information or data on roads, traffic control devices, road markings, structures, features, and/or landmarks in the one or more geographic areas. The map data 550 can include a terrain map 552 that includes information about the ground, terrain, roads, surfaces, and/or other features of one or more geographic areas. The terrain map 552 can include elevation data in the one or more geographic areas. The map data 550 can include one or more static obstacle map(s) 553. The static obstacle map(s) 553 can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, and hills. The static obstacles can be objects that extend above ground level. The one or more static obstacles included in the static obstacle map(s) 553 can have location data, size data, dimension data, material data, and/or other data associated with it. The static obstacle map(s) 553 can include measurements, dimensions, distances, and/or information for one or more static obstacles. The static obstacle map(s) 553 can be high quality and/or highly detailed. The static obstacle map(s) 553 can be updated to reflect changes within a mapped area.

The one or more data store(s) 540 can include sensor data 560. In this context, “sensor data” means any information about the sensors that the vehicle 100 is equipped with, including the capabilities and other information about such sensors. As will be explained below, the vehicle 100 can include a sensor system 120. The sensor data 560 can relate to one or more sensors of the sensor system 120.

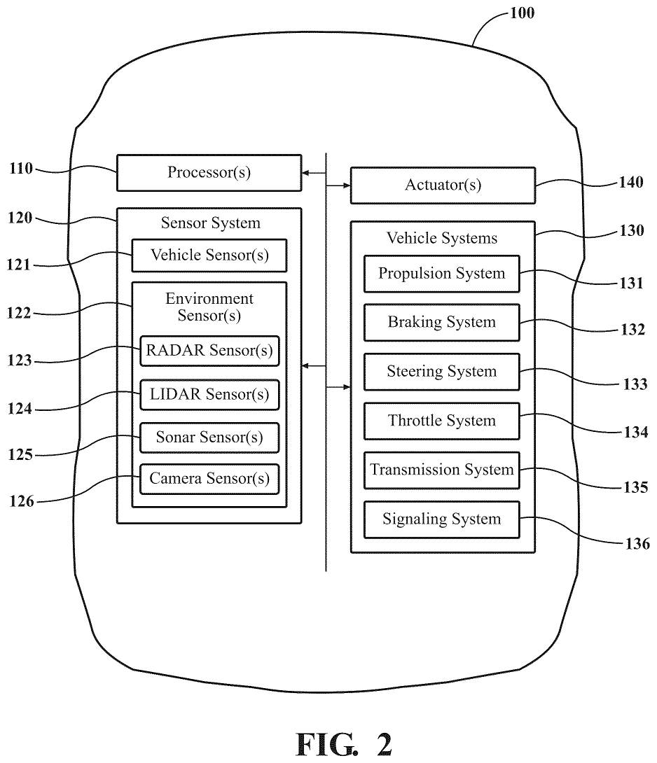

Referring to FIG. 2, an example of the vehicle 100 is illustrated. As used herein, a “vehicle” is any form of powered transport. In one or more implementations, the vehicle 100 is an automobile. While arrangements will be described herein with respect to automobiles, it will be understood that embodiments are not limited to automobiles. In some implementations, the vehicle 100 may be any robotic device or form of powered transport that may be remotely controlled.

The vehicle 100 also includes various elements. It will be understood that in various embodiments, it may not be necessary for the vehicle 100 to have all of the elements shown in FIG. 2. The vehicle 100 can have any combination of the various elements shown in FIG. 2.

Further, the vehicle 100 can have additional elements to those shown in FIG. 2. In some arrangements, the vehicle 100 may be implemented without one or more of the elements shown in FIG. 2. While the various elements are shown as being located within the vehicle 100 in FIG. 2, it will be understood that one or more of these elements can be located external to the vehicle 100. Further, the elements shown may be physically separated by large distances and provided as remote services (e.g., cloud-computing services).

Some of the possible elements of the vehicle 100 are shown in FIG. 2 and will be described along with subsequent figures. However, a description of many of the elements in FIG. 2 will be provided after the discussion of the figures for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. It should be understood that the embodiments described herein may be practiced using various combinations of these elements.

Returning to FIG. 1, as mentioned previously, the route determination system 600 can determine an appropriate route for the vehicle 100 to utilize to maintain communication with one or more non-terrestrial network nodes, such as the non-terrestrial network node 200, to allow for remote operation. In this example, the route determination system 600 is shown separately from the other components. However, it should be understood that route determination system 600 may be incorporated within other components, such as the vehicle 100 and/or the teleoperation center 500.

In either case, the route determination system 600 includes one or more processor(s) 610. Accordingly, the processor(s) 610 may be a part of route determination system 600 or the route determination system 600 may access the processor(s) 610 through a data bus or another communication path. In one or more embodiments, the processor(s) 610 is an application-specific integrated circuit that is configured to implement functions associated with an instruction module 622. In general, the processor(s) 610 is an electronic processor, such as a microprocessor, which is capable of performing various functions as described herein. In one embodiment, the route determination system 600 includes a memory 620 that stores the instruction module 622. The memory 620 is a random-access memory (RAM), read-only memory (ROM), a hard disk drive, a flash memory, or other suitable memory for storing the instruction module 622. The instruction module 622 is, for example, computer-readable instructions that, when executed by the processor(s) 610, cause the processor(s) 610 to perform the various functions disclosed herein.

Furthermore, in one embodiment, the route determination system 600 includes a data store(s) 630. The data store(s) 630 is, in one embodiment, an electronic data structure such as a database that is stored in the memory 620 or another memory and that is configured with routines that can be executed by the processor(s) 610 for analyzing stored data, providing stored data, organizing stored data, and so on. Thus, in one embodiment, the data store(s) 630 stores data used by the instruction module 622 in executing various functions. In one embodiment, the data store(s) 630 includes non-terrestrial network node information 632, obstacle information 634, and other information 636. As explained later, the non-terrestrial network node information 632 includes the trajectories of one or more non-terrestrial network nodes, such as the non-terrestrial network node 200. The trajectory information could also include future trajectory information, such as orbital information, regarding the trajectory of the non-terrestrial network nodes at some future time. The obstacle information 634 may contain information regarding one or more obstacles within a drivable area, which will be described later. Finally, the other information 636, which may be optional, could contain information regarding one or more constraints, such as allowable travel time, vehicle operation limitations (speed, acceleration, braking, etc.), allowable distance, allowable communication costs, etc.

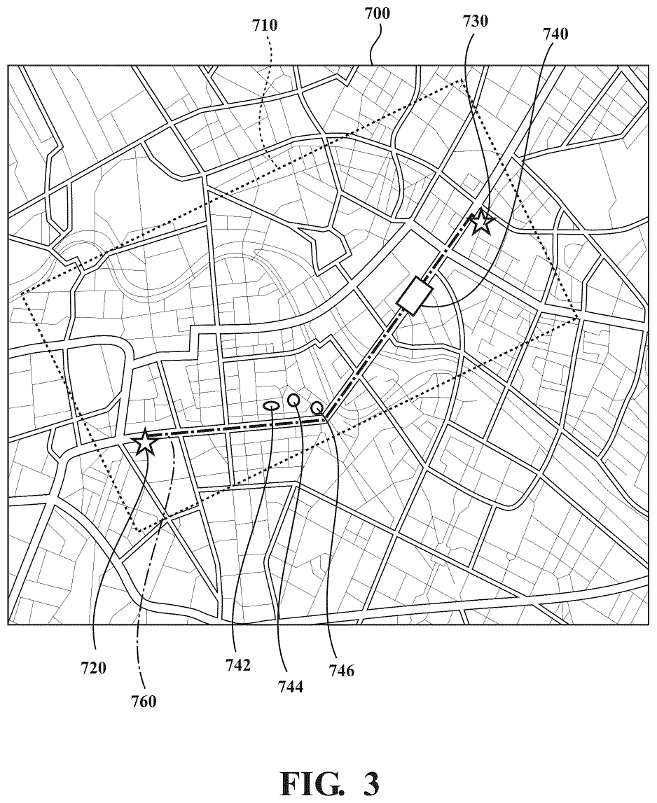

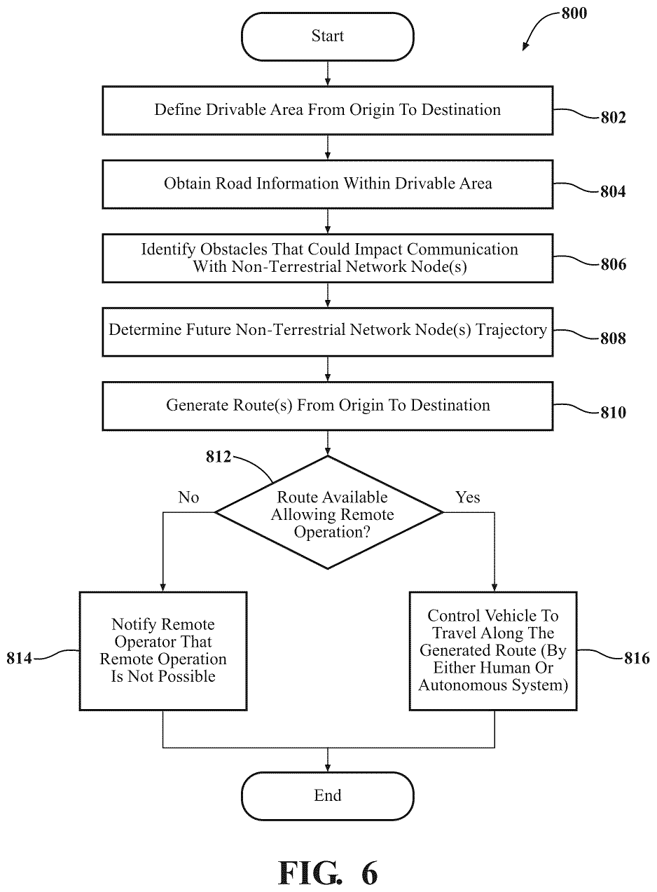

As mentioned, the instruction module 622 contains instructions that cause the processor(s) 610 to perform any of the methodologies described herein. With reference to FIG. 6, illustrated is a method 800 for determining a route for the vehicle 100 to utilize when the vehicle 100 is remotely controlled by sending and receiving signals using one or more non-terrestrial network nodes, such as the non-terrestrial network node 200. The method 800 will be described from the viewpoint of the route determination system 600 in FIG. 1. In addition to referring to the route determination system 600 of FIG. 1, reference will also be made to one or more components of the vehicle 100 of FIG. 2, and FIGS. 3-5 that illustrate examples of different routes that the route determination system 600 may determine when executing the method 800.

Additionally, it should be understood that this is just one example of implementing the method 800. While the method 800 is discussed in combination with the route determination system 600, it should be appreciated that the method 800 is not limited to being implemented within the route determination system 600, but is instead one example of a system that may implement the method 800. As such, the method 800 may be embodied within the instruction module 622 as processor-executable instructions that, when executed by the processor(s) 510, cause the processor(s) 510 to perform the method 800. For example, as mentioned before, the route determination system 600 could be integrated within other components, such as the vehicle 100, the teleoperation center 500, and/or other components not specifically shown.

In step 802, the instructions of the instruction module 622 cause the processor(s) 610 to define a drivable area that includes from an origin to a destination. Moreover, with reference to FIG. 3 illustrated is an electronic map 700, including numerous roads. In addition, also illustrated is an origin 720 and a destination 730, representing where the vehicle 100 is currently located (the origin 720) and where the vehicle 100 would like to travel to (the destination 730). Here, a drivable area 710 has been defined within the electronic map 700 to include both the origin 720 and the destination 730. The drivable area 710 may be defined by an operator using the input device(s) 530, the autonomous driving system 570, or may be preset through some other methodology. The drivable area 710 generally defines the area in which the vehicle 100 should stay within when traveling from the origin 720 to the destination 730. As such, the drivable area 710 may act as a constraint that limits the overall operating area of the vehicle 100.

In step 804, the instructions of the instruction module 622 cause the processor(s) 610 to obtain road information within the drivable area 710. For example, road information can be obtained from the vehicle 100, the teleoperation center 500, cloud servers, edge servers, or other electronic devices that may contain road-related information, such as speed limits, traffic signs, work zones, traffic lights, and the rest.

In addition, other information could also be collected that may place limits on the functionality of the vehicle 100. For example, information can be collected regarding maximum/minimum speed, maximum/minimum acceleration, maximum/minimum deceleration, maximum/minimum heading rate change, target speed, maximum/minimum travel time, maximum/minimum travel distance, and/or financial constraints as well, such as total costs associated with utilizing a non-terrestrial network node, such as the non-terrestrial network node 200, to relay communications between the vehicle 100 and the teleoperation center 500.

In step 806, the instructions of the instruction module 622 cause the processor(s) 610 to obtain obstacle information 634 regarding the identity, locations, dimensions, or other information regarding one or more obstacles located within the drivable area 710. Obstacle information can include things such as the location and dimensions of one or more obstacles such as trees, houses, walls, buildings, mountains, parked vehicles, or any type of obstacle that may interfere or block communication with one or more non-terrestrial network nodes, such as non-terrestrial network node 200. For example, referring to FIG. 3 illustrated are buildings 742, 744, and 746 that, depending on the trajectory of the non-terrestrial network node 200 and the location of the vehicle 100, may block signals from the non-terrestrial network node 200, inhibiting communication between the non-terrestrial network node 200 and the vehicle 100, preventing teleoperation of the vehicle 100. Also shown in this figure is a covered bridge 740 that will block signals from the non-terrestrial network node 200, regardless of the location of the non-terrestrial network node 200 and/or the vehicle 100. In addition, this step may also identify obstacles within the obstacle information 634 that may block signals from the non-terrestrial network node 200.

In addition, the obstacles may be dynamic in nature and may have the ability or may be moving. For example, larger vehicles, such as buses, tractor-trailers, etc. may potentially pose a risk of interfering with signals received from the non-terrestrial network node 200. In some cases, the instructions of the instruction module 622 cause the processor(s) 610 to determine the location and movements of these dynamic obstacles. In one example, the location of these dynamic obstacles may be provided by global navigation satellite system (“GNSS”) information from these dynamic obstacles. Future travel paths of these dynamic obstacles may be provided to a cloud server that can be accessible to the route determination system 600. As such, using the location and future travel paths, the route determination system 600 can also determine if these dynamic obstacles potentially could interfere with the reception of information from the non-terrestrial network node 200 by the vehicle 100.

In step 808, the instructions of the instruction module 622 cause the processor(s) 610 to determine the future trajectories of one or more non-terrestrial network nodes, such as the non-terrestrial network node 200. This can be accomplished by evaluating the non-terrestrial network node information 632 to determine the location of non-terrestrial network nodes that are capable of transmitting information to the vehicle 100 and their future locations based on trajectory information.

In step 810, the instructions of the instruction module 622 cause the processor(s) 610 to generate one or more routes from the origin 720 to the destination 730 that allow for the teleoperation of vehicle 100 from the teleoperation center 500, such that any obstacles will not impact communications between the non-terrestrial network node 200 and the vehicle 100. For example, referring back to FIG. 3, the drivable area 710 includes building 742, 744, and 746, and the covered bridge 740 that may impact the communication between the non-terrestrial network node 200 and the vehicle 100. Normally, the shortest route is illustrated by the route 760 between the origin 720 and the destination 730. Unfortunately, because of the buildings 742, 744, and 746 and the covered bridge 740, this route is not suitable for teleoperation, as these obstacles will interfere with the transmission of information between the vehicle 100 and the non-terrestrial network node 200.

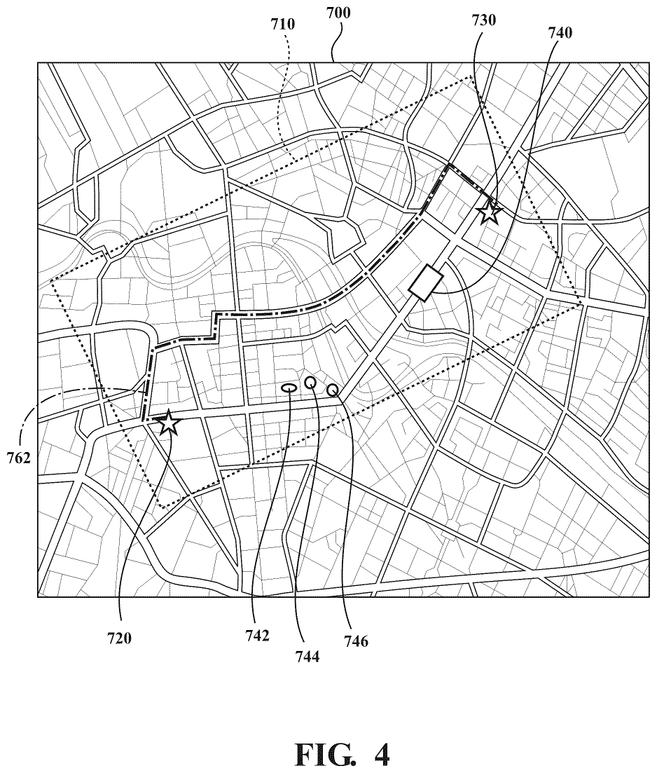

As such, the instructions of the instruction module 622 cause the processor(s) 610 to determine alternative routes that can avoid transmission interference. For example, FIG. 4 illustrates a route 762, which extends between the origin 720 and the destination 730. Notably, the route 762 is longer than that of the route 760 but is located such that communications between the vehicle 100 and the non-terrestrial network node 200 will not be impacted, as the route 762 avoids the buildings 742, 744, and 746 and the covered bridge 740. As such, the route 762 may be one of the routes generated for the vehicle 100 to utilize to allow for the teleoperation of vehicle 100.

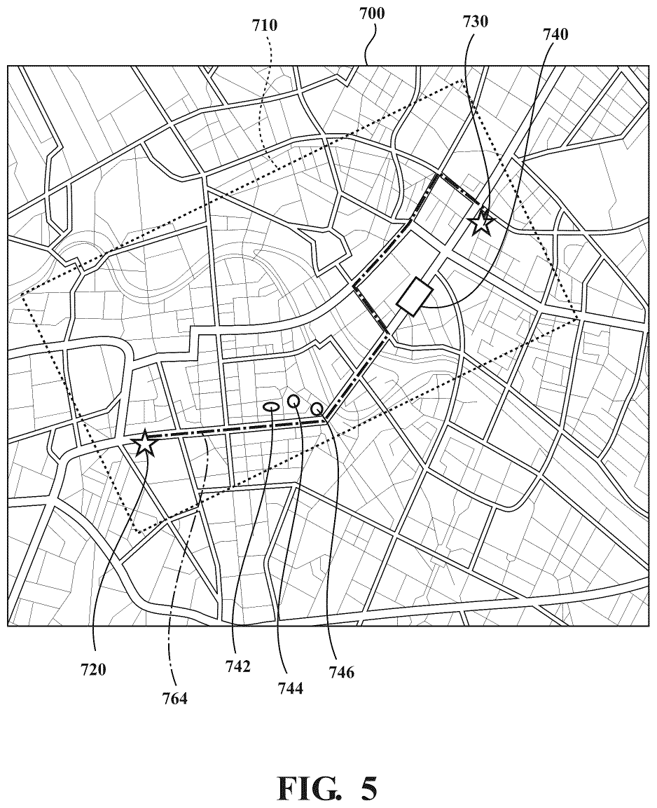

Because non-terrestrial network nodes are in motion and may be located at different locations with respect to the vehicle 100, there may be situations where certain obstacles do not represent a potential communication disruption. For example, FIG. 5 illustrates a route 764, which generally passes near the buildings 742, 744, and 746. The route 764 may be appropriate in some situations where the location of the non-terrestrial network node 200 with respect to the vehicle 100 is such that there is a good line of sight between the vehicle 100 and the non-terrestrial network node 200. However, as to the covered bridge 740, due to the nature of the structure of the covered bridge 740, this object will need to be avoided regardless of the position of the non-terrestrial network node 200 with respect to the vehicle 100.

In addition to avoiding communication disruptions by considering the future trajectory of non-terrestrial network nodes and the location of problematic objects, other constraints can also be utilized to determine the appropriate route. For example, routes of a be generated that satisfy certain thresholds such as a travel time threshold that indicates a maximum amount of time for the vehicle 100 to travel from the origin 720 to the destination 730, a distance threshold that indicates a maximum distance for the vehicle 100 to travel from the origin 720 to the destination 730, arrival times for one or more waypoints along a particular route, a recommended speed, a speed range of one or more segments of the route, a signal strength threshold representing the minimum the signal strength between the non-terrestrial network node 200 and the vehicle 100, a trip cost threshold indicating a financial cost for controlling the vehicle 100 using the non-terrestrial network node 200, and potentially other constraints as well.

In step 812, the instructions of the instruction module 622 cause the processor(s) 610 to determine if at least one route has been generated that allows for remote operation and also satisfies any constraints (if any). As shown in step 814, if no route can be generated that safely allows for the teleoperation of vehicle 100 and satisfies any constraints, the instructions of the instruction module 622 cause the processor(s) 610 to notify the teleoperation center 500 that remote operation is not possible. This notification may be provided to a human operator located at the teleoperation center 500 and/or may be provided to the autonomous driving system 570.

However, as shown in step 816, if a route can be generated that safely allows for the teleoperation of the vehicle 100 and satisfies any constraints, the processor(s) 610 allows for the remote teleoperation of the vehicle 100 from the teleoperation center 500. As explained previously, this may be allowing a human operator to control the movement of the vehicle 100 using the input device(s) 530 and receive sensor information from the vehicle 100 by the output device(s) 520. In situations where the autonomous driving system 570 is utilized, the autonomous driving system 570 can receive sensor information from the vehicle 100 and send control signals to the vehicle 100.

FIG. 2 will now be discussed in full detail. The vehicle 100 can include one or more processor(s) 110. In one or more arrangements, the processor(s) 110 can be the main processor of the vehicle 100. For instance, the processor(s) 110 can be an electronic control unit (ECU). As noted above, the vehicle 100 can include the sensor system 120. The sensor system 120 can include one or more sensors. “Sensor” means any device, component, and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made or that enables the processor to keep up with some external process.

In arrangements in which the sensor system 120 includes a plurality of sensors, the sensors can work independently from each other. Alternatively, two or more of the sensors can work in combination with each other. In such a case, the two or more sensors can form a sensor network. The sensor system 120 and/or the one or more sensors can be operatively connected to the processor(s) 110 and/or another element of the vehicle 100. The sensor system 120 can acquire data from at least a portion of the external environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensor(s) 121. The vehicle sensor(s) 121 can detect, determine, and/or sense information about the vehicle 100 itself. In one or more arrangements, the vehicle sensor(s) 121 can be configured to detect, and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation non-terrestrial network node system (GNSS), a global positioning system (GPS), a navigation system, and /r other suitable sensors. The vehicle sensor(s) 121 can be configured to detect, and/or sense one or more characteristics of the vehicle 100. In one or more arrangements, the vehicle sensor(s) 121 can include a speedometer to determine the current speed of the vehicle 100.

The sensor system 120 can include one or more environment sensors 122 configured to acquire and/or sense driving environment data. “Driving environment data” includes data or information about the external environment in which an autonomous vehicle is located or one or more portions thereof. For example, the one or more environment sensors 122 can be configured to detect, quantify, and/or sense obstacles in at least a portion of the external environment of the vehicle 100 and/or information/data about such obstacles. Such obstacles may be stationary objects and/or dynamic objects. The one or more environment sensors 122 can be configured to detect, measure, quantify, and/or sense other things in the external environment of vehicle 100, such as, for example, lane markers, signs, traffic lights, traffic signs, lane lines, crosswalks, curbs proximate the vehicle 100, off-road objects, etc.

Various examples of sensors of the sensor system 120 will be described herein. The example sensors may be part of the one or more environment sensors 122 and/or the one or more vehicle sensor(s) 121. However, it will be understood that the embodiments are not limited to the particular sensors described.

As an example, in one or more arrangements, the sensor system 120 can include one or more radar sensors 123, one or more LIDAR sensors 124, one or more sonar sensors 125, and/or one or more cameras 126. In one or more arrangements, the one or more cameras 126 can be high dynamic range (HDR) cameras or infrared (IR) cameras.

The vehicle 100 can include one or more vehicle systems 130. Various examples of the one or more vehicle systems 130 are shown in FIG. 2. However, the vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 131, a braking system 132, a steering system 133, a throttle system 134, a transmission system 135, and/or a signaling system 136. Each of these systems can include one or more devices, components, and/or a combination thereof, now known or later developed.

The vehicle 100 can include one or more actuators 140. The actuators 140 can be any element or combination of elements operable to modify, adjust and/or alter one or more of the vehicle systems 130 or components thereof to be responsive to receiving signals or other inputs from the processor(s) 110. Any suitable actuator can be used. For instance, the one or more actuators 140 can include motors, pneumatic actuators, hydraulic pistons, relays, solenoids, and/or piezoelectric actuators, just to name a few possibilities.

In particular, during the teleoperation (remote control) of the vehicle 100, commands issued from the teleoperation center 500 may control one or more of the vehicle systems 130 and/or one or more actuators 140 to control the operation and movement of the vehicle 100 from traveling from one location to another.

In one or more arrangements, one or more of the modules described herein can include artificial or computational intelligence elements, e.g., neural networks, fuzzy logic, or other machine learning algorithms. Further, in one or more arrangements, one or more of the modules can be distributed among a plurality of the modules described herein. In one or more arrangements, two or more of the modules described herein can be combined into a single module.

Detailed embodiments are disclosed herein. However, it is to be understood that the disclosed embodiments are intended only as examples. Therefore, specific structural and functional details disclosed herein are not to be interpreted as limiting but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any processing system or another apparatus adapted for carrying out the methods described herein is suited. A typical combination of hardware and software can be a processing system with computer-usable program code that, when being loaded and executed, controls the processing system such that it carries out the methods described herein. The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, module as used herein includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++, or the like, and conventional procedural programming languages, such as the “C” programming language or similar programming languages. The program code may execute entirely on the user's computer, partly on the user's computer, as a stand-alone software package, and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims rather than to the foregoing specification, as indicating the scope hereof.

1. A system comprising a memory having instructions that, when executed by a processor, cause the processor to:
determine a route from an origin to a destination within a defined drivable area such that movement of a vehicle along the route can be remotely controlled in real time from a teleoperation center remote from the vehicle, based on a future trajectory of a non-terrestrial network node that will relay control signals from the teleoperation center to the vehicle for controlling movement of the vehicle along the route when the vehicle travels from the origin to the destination and obstacle information of obstacles that could inhibit the vehicle from receiving the control signals from the non-terrestrial network node; and
control the vehicle to travel along the route with the control signals from the non-terrestrial network node.

2. The system of claim 1, wherein the memory further includes instructions that, when executed by the processor, cause the processor to determine the route further based on at least one of a recommended speed and a speed range of one or more segments of the route.

3. The system of claim 1, wherein the memory further includes instructions that, when executed by the processor, cause the processor to determine the route further based on arrival times for one or more waypoints along the route.

4. The system of claim 1, wherein the memory further includes instructions that, when executed by the processor, cause the processor to determine the route further based on at least one of a travel time threshold and a distance threshold.

5. The system of claim 4, wherein:
the travel time threshold indicates a maximum amount of time for the vehicle to travel from the origin to the destination; and
the distance threshold indicates a maximum distance for the vehicle to travel from the origin to the destination.

6. The system of claim 1, wherein the memory further includes instructions that, when executed by the processor, cause the processor to determine the route further based on a received signal strength threshold.

7. The system of claim 6, wherein the received signal strength threshold is a minimum signal strength between the vehicle and the non-terrestrial network node.

8. The system of claim 1, wherein the memory further includes instructions that, when executed by the processor, cause the processor to determine the route further based on a trip cost threshold, indicating a financial cost of controlling the vehicle using the non-terrestrial network node.

9. The system of claim 1, wherein the non-terrestrial network node is a Low Earth Orbit (LEO) satellite.

10. A method comprising:
determining a route from an origin to a destination within a defined drivable area such that movement of a vehicle along the route can be remotely controlled in real time from a teleoperation center remote from the vehicle, based on a future trajectory of a non-terrestrial network node that will relay control signals from the teleoperation center to the vehicle for controlling movement of the vehicle along the route when the vehicle travels from the origin to the destination and obstacle information of obstacles that could inhibit the vehicle from receiving the control signals from the non-terrestrial network node; and
controlling the vehicle to travel along the route with the control signals from the non-terrestrial network node.

11. The method of claim 10, further comprising determining the route further based on at least one of a recommended speed and a speed range of one or more segments of the route.

12. The method of claim 10, further comprising determining the route further based on arrival times for one or more waypoints along the route.

13. The method of claim 10, further comprising determining the route further based on at least one of a travel time threshold and a distance threshold.

14. The method of claim 13, wherein:
the travel time threshold indicates a maximum amount of time for the vehicle to travel from the origin to the destination; and
the distance threshold indicates a maximum distance for the vehicle to travel from the origin to the destination.

15. The method of claim 10, further comprising determining the route further based on a received signal strength threshold.

16. The method of claim 15, wherein the received signal strength threshold is a minimum signal strength between the vehicle and the non-terrestrial network node.

17. The method of claim 10, further comprising determining the route further based on a trip cost threshold, indicating a financial cost of controlling the vehicle using the non-terrestrial network node.

18. The method of claim 10, wherein the non-terrestrial network node is a Low Earth Orbit (LEO) satellite.

19. A non-transitory computer-readable medium comprising instructions that, when executed by a processor, cause the processor to:
determine a route from an origin to a destination within a defined drivable area such that movement of a vehicle along the route can be remotely controlled in real time from a teleoperation center remote from the vehicle, based on a future trajectory of a non-terrestrial network node that will relay control signals from the teleoperation center to the vehicle for controlling movement of the vehicle along the route when the vehicle travels from the origin to the destination and obstacle information of obstacles that could inhibit the vehicle from receiving the control signals from the non-terrestrial network node; and
control the vehicle to travel along the route with the control signals from the non-terrestrial network node.

20. The non-transitory computer-readable medium of claim 19, further comprising instructions that, when executed by the processor, cause the processor to determine the route further based on at least one of:
a recommended speed and a speed range of one or more segments of the route;
arrival times for one or more waypoints along the route;
a travel time threshold;
a distance threshold;
a received signal strength threshold;
a minimum signal strength between the vehicle and the non-terrestrial network node; and
a trip cost threshold, indicating a financial cost of controlling the vehicle using the non-terrestrial network node.
